(19) United States
(12) Patent Application Publication
(10) Pub. No.: US 2012/0103907 A1
(43) Pub. Date: May 3, 2012

(54) MANGANESE BASED SORBENT FOR REMOVAL OF MERCURY SPECIES FROM FLUIDS

(76) Inventors: John MacKinnon, Vernon Hills, IL (US); Sheryl Ivy, Channahon, IL (US)

(21) Appl. No.: 12/996,720

(22) PCT Filed: Nov. 3, 2010
(86) PCT No.: PCT/US10/55320

§ 371 Date: Dec. 7, 2010

(51) Int. Cl. B01D 15/00; B01D 53/64; C09K 3/32

(52) U.S. Cl. 210/660; 252/184; 423/210

(57) ABSTRACT

An embodiment of the present invention provides a modified hydrous manganese oxide particle for use as a sorbent for the removal of mercury from a fluid. The modified hydrous manganese oxide particle in one embodiment incorporates sulfur into the manganese oxide matrix. In a further embodiment, the modified hydrous manganese oxide particle of the present invention incorporates a halogen into the matrix of the manganese oxide. In a still further embodiment, the hydrous manganese oxide particle incorporates a transition metal into the matrix of the manganese oxide.

### FIELD OF THE INVENTION

The present invention and its embodiments relates to the manufacture and use of hydrous manganese oxide sorbents directed to the removal of elemental mercury and oxidized mercury from fluid streams.

### BACKGROUND OF THE INVENTION

Mercury is a well-documented toxic contaminant of various fluid streams. Mercury, for example, may be a contaminant of exhaust gases generated during the combustion of fossil fuels or refuse. Mercury may also be a contaminant of process liquids which are generated, for example, in manufacturing processes which utilize mercury or in remedial processes which attempt to remove mercury from materials or other fluid streams.

Most typically the removal of mercuric contaminants from fluid streams is solved by activated carbons being added to the fluid, either liquid or gas. The activated carbon adsorbs the mercury species removing it from the fluid. Other typical sorbents used for achieving this goal include zeolites, clays and fly ash.

Adsorption promoters, which typically include sulfides or halides, have been added to activated carbon and the modified activated carbon used as a sorbent for the removal of mercury from gas streams. The use of the adsorption promoters are thought to improve the mercury removal efficiency of activated carbon. It is believed that the halide or sulfide species used to modify the activated carbon are effective Hg²⁺-couplers which minimize the leachability of mercury from the activated carbon.

Manganese oxide is known to adsorb mercury (II) from aqueous solutions and from air streams such as power plant flue exhaust. Manganese oxide is an oxidant and is used, for example, in organic oxidation reactions. It is believed that manganese oxide has the ability to oxidize mercuric species on contact.

What is needed is a hydrous manganese oxide based sorbent that is de-agglomerated and, optionally, modified to effect oxidation, adsorption and capture of mercury species.

### SUMMARY OF THE INVENTION

Embodiments of the present invention provide a hydrous manganese oxide modified with inorganic salts which shows a particular efficacy for the removal of mercury and mercury compounds from fluid streams. According to one embodiment of the present invention, hydrous manganese oxide was modified upon precipitation with sulfide salts such as ammonium or sodium sulfide, or chloride, bromide or iodide salts. Generally, halogens, alkali metal halides and transition metal halides may be used in embodiments of the present invention.

Embodiments of the present invention provide an oxidized form of a sulfide or halide additive, which is impregnated on the surface of the highly adsorptive manganese oxide oxidant. Manganese oxides are able to oxidize, at least partially, the sulfide or halide additives within the manganese oxide surface pores.

Embodiments of the present invention provide a sorbent that is effective for removing mercury, both elemental mercury and oxidized forms of mercury, from a fluid, wherein the sorbent is a hydrous manganese oxide having a pore structure and has a sulfur compound impregnated in the pore structure of the hydrous manganese oxide. Embodiments of the present invention further provide a sorbent that is effective for such removing mercury from a fluid, wherein the sorbent is a hydrous manganese oxide having a pore structure and has a sulfur compound and a halogen compound impregnated in the pore structure of the hydrous manganese oxide. Embodiments of the present invention further provide a sorbent that is effective for removing such mercury from a fluid, wherein the sorbent is a hydrous manganese oxide having an oxidizable material adsorbed on to the hydrous manganese oxide such that the oxidizable material is adsorbed prior to its oxidation. Furthermore, embodiments of the present invention provide a sorbent that is effective for removing such mercury from a fluid, wherein the sorbent is a hydrous manganese oxide having a pore structure and having a sulfur compound and a halogen compound impregnated in the pore structure of the hydrous manganese oxide and, optionally, a transition-metal compound impregnated in the pore structure of the hydrous manganese oxide.

Embodiments of the present invention provide a sorbent that is effective for removing mercury, whether elemental mercury or an oxidized form of mercury such as a mercury compound, from a fluid, wherein the sorbent is a de-agglomerated hydrous manganese oxide particle. Embodiments of the present invention provide methods for making un-modified, modified and de-agglomerated hydrous manganese oxides.

The sorbents of the present invention and embodiments thereof enhance the ability for the adsorption of mercury species to occur through a combined process of adsorption, oxidation and reaction with sulfide or halide to form a stable form of mercury with the sorbent of the present invention and embodiments thereof. The sorbents of the present invention and embodiments thereof may be used for the removal of mercury contaminants from a liquid such as water, from an air stream such as in a flue gas from a power plant, or from a hydrocarbon stream.

### BRIEF DESCRIPTION OF THE DRAWINGS

FIG. 1 is a schematic diagram of the test apparatus used to test the efficacy of embodiments of the present invention as mercury sorbents at elevated temperatures.

FIG. 2 is a graph of the results of a digital thermogravimetric analysis of δ-hydrous manganese oxide made according to the principals of the present invention.

FIG. 3 is a graph of the results of a digital thermogravimetric analysis of β-hydrous manganese oxide made according to the principals of the present invention.

FIG. 4 is a graph of the results of a leaching study performed at 25° C. comparing the performance of δ-hydrous manganese oxide made according to the principals of the present invention and activated carbon.

FIG. 5 is a graph of the results of a leaching study performed at 60° C. comparing the performance of δ-hydrous manganese oxide made according to the principals of the present invention and activated carbon.

FIG. 6 is a graph of the results of a leaching study performed at 25° C. comparing the performance of a 2% sulfurized δ-hydrous manganese oxide made according to the principals of the present invention and a control.

FIG. 7 is a graph of the results of a leaching study performed at 60° C. comparing the performance of a 2% sulfurized δ-hydrous manganese oxide made according to the principals of the present invention and a control.

FIG. 8 is a graph of the results of a leaching study performed at 25° C. comparing the performance of a 7% sulfurized δ-hydrous manganese oxide made according to the principals of the present invention and a control.

FIG. 9 is a graph of the results of a leaching study performed at 60° C. comparing the performance of a 7% sulfurized δ-hydrous manganese oxide made according to the principals of the present invention and a control.

FIG. 10 is a graph of the results of a leaching study performed at 25° C. comparing the performance of an unmodified δ-hydrous manganese oxide made according to the principals of the present invention and a control.

FIG. 11 is a graph of the results of a leaching study performed at 60° C. comparing the performance of an unmodified δ-hydrous manganese oxide made according to the principals of the present invention and a control.

### DETAILED DESCRIPTION OF THE PREFERRED EMBODIMENTS

The sorbent of the present invention and embodiments thereof comprise a hydrous manganese oxide (“HMO”) and sulfide oxidized within the manganese oxide surface pores. Furthermore, the sorbent of the present invention and embodiments thereof comprise an HMO and a halide or halogen species. The sorbent of the present invention and embodiments thereof also comprise a de-agglomerated un-modified HMO. As provided below, sulfide and/or halide species are impregnated in the surface of HMO and thus provide a sorbent with oxidation and mercury capture properties. Furthermore, as provided below, de-agglomerated and un-modified HMO made according to the principles of the present invention is an effective mercury sorbent. Hydrous manganese oxide sorbents of the present invention and embodiments thereof exhibit enhanced adsorbent capacity over unmodified manganese oxides.

Hydrous manganese oxide contains varying amounts of chemically bound water and typically exists as an amorphous solid that is insoluble in water. The general formula for hydrous manganese oxide is MnOₓ.yH₂O, where x=1 to 2 and y=0.1 to 6. Forms of HMO include, but are not limited to, beta-hydrous manganese oxide, delta-hydrous manganese oxide and hausmannite. Hausmannite is an oxide of manganese which contains both di- and tri-valent manganese. For embodiments of the present invention, a preferred form of HMO is delta manganese oxide impregnated with sodium sulfide and an adjunct compound consisting of copper bromide to form an augmented sulfurized hydrous manganese oxide, and alternatively delta-hydrous manganese oxide impregnated with sodium sulfide and an adjunct compound consisting of copper chloride to form an augmented sulfurized hydrous manganese oxide, as more fully described herein below. Another preferred form of the HMO of the present invention and embodiments thereof is a sulfurized HMO.

Methods of making embodiments of the present invention are described herein below. Additionally, tests of the efficacy of embodiments of the present invention as an adsorbent are described together with the results of such tests.

### Modified HMO

HMO was made in the laboratory according to the following examples. Other methods for making HMO will be known to those of ordinary skill in the art and are included within the scope of the present disclosure.

### Example 1

Delta-Hydrous Manganese Oxide was made in a laboratory according to the following methodology:

1. A 20% w/w solution of sodium permanganate (NaMnO₄) was purchased for use in this Example 1 and the examples described below. 20% w/w solutions of sodium permanganate are available from Cams Corporation, Peru, Ill.

2. A 30% w/w solution of manganese sulfate monohydrate (MnSO₄.H₂O) was purchased for use in this Example 1 and the examples described below. 30% w/w solution of manganese sulfate monohydrate is available from Carus Corporation, Peru, Ill.

3. 5.12 grams (g) of the 20% w/w solution of step 1 was added to 88.79 grams (g) of deionized water, thus forming a step 3 solution;

4. 6.09 grams (g) of the 30% w/w solution of manganese sulfate monohydrate of step 2 was added to the step 3 solution, thus forming a step 4 solution;

5. the step 4 solution was stirred at 22° C. overnight allowing HMO to precipitate;

6. the precipitated HMO of step 5 was filtered through MILLIPORE nitrocellulose 0.22 μM GSWP filters and washed under vacuum with 10 volumes of deionized water then dried in an oven at 110° C. for 2 hours; and

7. the dried HMO of step 6 was ground to a fine powder using a mortar and pestle, thus making the HMO of Example 1.

### Example 1a-1d

Delta-Hydrous Manganese Oxide was made in a laboratory according to the following methodology to study the effect of water addition on yield.

1. 5.09 grams (g) of a purchased 20% w/w solution of sodium permanganate was added to varying amounts of deionized water as shown in Table 1 below, thus forming a step 1 solution;

2. 6.12 grams (g) of a purchased 30% w/w solution of manganese sulfate monohydrate was added to the step 1 solution, thus forming a step 2 solution;

3. the step 2 solution was stirred at 22° C. overnight allowing HMO to precipitate;

4. the precipitated HMO of step 3 was filtered through MILLIPORE nitrocellulose 0.22 μM GSWP filters and washed under vacuum with 10 volumes of deionized water then dried in an oven at 110° C. for 2 hours; and

5. the dried HMO of step 4 was ground to a fine powder using a mortar and pestle, thus making the HMO of Examples 1a-1d.

TABLE 1

| | Amount of water added in | | Yield of HMO, |
|---|---|---|---|
| Example | step 3, units indicated | | grams |
| 1a | 88.8 | grams (g) | 1.75 |
| 1b | 60 | grams (g) | 1.77 |
| 1c | 35 | milliliters (mL) | 1.74 |
| 1d | 10 | milliliters (mL) | 1.76 |

In Example 1, 0.0072 mole of sodium permanganate was combined with 0.018 mole of manganese sulfate monohydrate in water according to the methodology of Example 1. The reaction yielded 1.54 grams (g) of HMO. This is an 88.5% yield compared to a theoretical yield of 1.739 grams (g). Preferably, the ratio of sodium permanganate to manganese sulfate monohydrate is nominally 0.4. As will be recognized by persons having ordinary skill in the art, the reaction between sodium permanganate and manganese sulfate monohydrate is a quantitative reaction. Thus, persons having ordinary skill in the art will recognize that other stoichiometric ratios of sodium permanganate to manganese sulfate monohydrate may be employed to make δ-hydrous manganese oxide. The pH of the δ-HMO prepared according to the Examples 1a-1d was nominally 1.5. The pH range of the δ-HMO prepared according to the principles of the present invention and embodiments thereof is primarily determined by the molar ratio of sodium permanganate to manganese sulfate monohydrate, although other conditions may influence the pH as will be understood by persons of ordinary skill in the art.

### Example 2

Beta-Hydrous Manganese Oxide was made in a laboratory according to the following methodology:
1. 10.14 grams (g) of the 30% w/w solution of manganese sulfate monohydrate of step 2 in Example 1 was added to 50 milliliters (mL) of deionized water forming a step 1 solution;
2. 3.4 milliliters (mL) of concentrated nitric acid was added to the step 1 solution forming a step 2 solution;
3. the step 2 solution was stirred and heated to reflux;
4. 12 grams of the 20% w/w solution of sodium permanganate of step 1 in Example 1 was added slowly to the refluxing step 2 solution of step 3 in order to maintain reflux, thus forming a step 4 suspension;
5. the step 4 suspension was refluxed with stirring overnight then cooled to room temperature allowing HMO to form;
6. the HMO of step 5 was filtered through MILLIPORE nitrocellulose 0.22 μM GSWP filters and washed under vacuum with 10 volumes of deionized water then dried in an oven at 110° C. for 2 hours; and
7. the dried HMO of step 6 was ground to a fine powder using a mortar and pestle, thus making the HMO of Example 2.

In Example 2, 0.06 mole of manganese sulfate monohydrate was combined with 0.085 mole of sodium permanganate in water and according to the methodology of Example 2. The reaction yielded 16.1 grams of HMO.

The percentage of sulfur contained in the sulfurized HMO in the HMO samples of Examples 3, 3a-3c and 4, further described herein below, was determined according to the following method (the “ICP Method”). 20 milligrams (mg) of the sulfurized HMO was added to 2 milliliters (mL) of 30% w/w hydrogen peroxide in 13 milliliters (mL) of 20% w/w HCl. The thus formed suspension was heated at 65° C. until all solids were digested, which typically required 10 to 15 minutes of heating. The thus formed solution was then filtered through a MILLIPORE nitrocellulose 0.22 μM GSWP filter. The filtered sample was then introduced into a PERKIN ELMER Optima 3300 RL ICP with a PERKIN ELMER S10 Autosampler to determine sulfur content.

### Example 3

Sulfurized HMO was made in a laboratory using ammonium sulfide according to the following methodology. Other sulfides and other oxidation states of sulfur may be used. Without being bound to specific examples, embodiments of the present invention may be prepared using sulfur compounds wherein the sulfur oxidation state may range from −2 to +6.
1. 2 grams (g) of dried HMO of Example 1a was stirred in 20 milliliters (mL) of deionized water for 30 minutes using a stir bar and stir plate, thus making a suspension of step 1;
2. 800 microliters (μL) of ammonium sulfide as an approximately 44% w/w solution, available from Sigma Aldrich Corporation, Milwaukee, Wis. as a “40 to 48%” solution, was added to the suspension of step 1, thus making the suspension of step 2;
3. the suspension of step 2 was stirred at 22° C. for 1 hour and then filtered through MILLIPORE nitrocellulose 0.22 μM GSWP filters and washed under vacuum with 10 volumes of deionized water then dried in an oven at 110° C. for 2 hours, thus forming a dried sulfurized HMO; and.
4. the dried sulfurized HMO of step 3 was ground to a fine powder using a mortar and pestle, thus making the sulfurized HMO of Example 3.

### Example 3a

Sulfurized HMO was made in a laboratory using ammonium sulfide according to the following methodology.
1. 2 grams (g) of dried HMO of Example 1a was stirred in 20 milliliters (mL) of deionized water for 30 minutes using a stir bar and stir plate and the pH adjusted to 7, thus making a suspension of step 1;
2. 800 microliters (μL) of ammonium sulfide as an approximately 44% w/w solution was added to the suspension of step 1, thus making the suspension of step 2;
3. the suspension of step 2 was stirred at 60° C. for 1 hour and then filtered through MILLIPORE nitrocellulose 0.22 μM GSWP filters and washed under vacuum with 10 volumes of deionized water then dried in an oven at 110° C. for 2 hours, thus forming a dried sulfurized HMO; and.
4. the dried sulfurized HMO of step 3 was ground to a fine powder using a mortar and pestle, thus making the sulfurized HMO of Example 3a.

### Example 3b

Sulfurized HMO was made in a laboratory using ammonium sulfide according to the following methodology.
1. 1 gram (g) of dried HMO of Example 1a was stirred in 20 milliliters (mL) of deionized water for 30 minutes using a stir bar and stir plate and the pH adjusted to 7, thus making a suspension of step 1;
2. 200 microliters (μL) of ammonium sulfide as an approximately 44% solution was added to the suspension of step 1, thus making the suspension of step 2;
3. the suspension of step 2 was stirred at 60° C. for 1 hour and then filtered through MILLIPORE nitrocellulose 0.22 μM GSWP filters and washed under vacuum with 150 milliliters of deionized water then dried overnight at room temperature and subsequently in an oven at 100° C. for 1 hour, thus forming a dried sulfurized HMO; and.
4. the dried sulfurized HMO of step 3 was ground to a fine powder using a mortar and pestle, thus making the sulfurized HMO of Example 3b.

### Example 3c

Sulfurized HMO was made in a laboratory using ammonium sulfide according to the following methodology.
1. 1 gram (g) of dried HMO of Example 1a, which had been dried overnight at room temperature and then in an oven for 1 hour at 60° C., was stirred in 10 milliliters (mL) of deionized water for 30 minutes using a stir bar and stir plate and the pH adjusted to 7, thus making a suspension of step 1;
2. 100 microliters (μL) of ammonium sulfide as an approximately 44% w/w solution was added to the suspension of step 1, thus making the suspension of step 2;
3. the suspension of step 2 was stirred at room temperature for 1 hour and then filtered through MILLIPORE nitrocellulose 0.22 μM GSWP filters and washed under vacuum with 150 milliliters (mL) of deionized water then dried overnight at room temperature and then for 1 hour at 100° C., thus forming a dried sulfurized HMO; and.
4. the dried sulfurized HMO of step 3 was ground to a fine powder using a mortar and pestle, thus making the sulfurized HMO of Example 3c.

In Example 3, 0.023 mole of the dried HMO of Example 1a was treated with 0.2 equivalents, or 0.0045 mole, of ammonium sulfide according to the methodology of Example 3. In Example 3a, 0.023 mole of the dried HMO of Example 1a was treated with 0.2 equivalents, or 0.0045 mole, of ammonium sulfide according to the methodology of Example 3a. The percentage of sulfur in both of the sulfurized HMO's of Examples 3 and 3a was determined using the ICP technique to be 7%. In Example 3b, the percent sulfur was determined to be 1.7%. In Example 3c, the percent sulfur was determined to be 2.29%.

### Example 4

Sulfurized HMO was made in a laboratory using sodium sulfide according to the following methodology.
1. 2 grams (g) of dried HMO of Example 1a was stirred in 20 milliliters (mL) of deionized water for 30 minutes using a stir bar and stir plate thus making a suspension of step 1;
2. 0.36 grams (g) of sodium sulfide was added to the suspension of step 1, thus making the suspension of step 2;
3. the suspension of step 2 was stirred at 22° C. for 1 hour and then filtered through MILLIPORE nitrocellulose 0.22 μM GSWP filters and washed under vacuum with 10 volumes of deionized water then dried in an oven at 110° C. for 2 hours, thus forming a dried sulfurized HMO; and
4. the dried sulfurized HMO of step 3 was ground to a fine powder using a mortar and pestle, thus making the sulfurized HMO of Example 4.

In Example 4, 0.023 mole of the dried HMO of Example 1a was treated with 0.2 equivalents, or 0.0045 mole, of sodium sulfide according to the methodology of Example 4. The percentage of sulfur in the sulfurized HMO of Example 4 was determined to be 7%.

In preparing sulfurized HMO the following variations apply. As noted above, other crystal forms of hydrous manganese oxide can be used in this process. The crystal forms include but are not limited to beta hydrous manganese oxide, delta hydrous manganese oxide, and hausmannite. Furthermore, other methodologies for making hydrous manganese oxide can be used in this process other than the ones described above. In the examples provided herein, the pH for water used in preparing the examples herein is preferably in the range of 0.9 to 8. The pH of the water used in preparing the examples herein may range from 0.9 to 14. The temperature at which the suspensions of the sulfurized Examples are stirred can range from 20° C. to 60° C.

The percent sulfur in a sulfurized HMO of the present invention and embodiments thereof is preferably 5% to 10% by weight and can range from 1% to 30% by weight.

While the examples provided illustrate the use of ammonium sulfide and sodium sulfide in making sulfurized HMO's of the present invention, other sulfides, such as hydrogen sulfide and polysulfides, may also be used.

### Example 5

Copper addition to HMO was made in a laboratory using cupric chloride according to the following methodology. Other transition metal-bearing compounds may be used in embodiments of the present invention. Without being bound by specific examples, transition metal-bearing compounds which may be used in embodiments of the present invention include iron compounds and zinc compounds. Copper (II) acts as couple with manganese in a oxidation-reduction (“redox”) couple. Manganese is oxidized from Mn(II) back to Mn(IV) with the presence of attached oxygen on the surface after a reaction with mercury and mercury compounds. The copper-manganese redox couple occurs at elevated temperatures and effectively catalyzes the mercury removal cycle. The copper therefore imparts stability to the manganese structure as well as enhancing the catalytic affect, thus maintaining the adsorbing structure. The evidence is shown in higher temperature gaseous mercury removal. Accordingly, the presence of copper in the manganese sorbent of the present invention and embodiments thereof fulfills a dual role.
1. 2 grams (g) of a dried sulfurized-HMO of Example 3 was stirred in 20 milliliters (mL) of deionized water for 30 minutes using a stir bar and stir plate, thus making a suspension of step 1;
2. 0.4 grams (g) of copper chloride dihydrate was added to the suspension of step 1, thus making the suspension of step 2;
3. the suspension of step 2 was stirred at 22° C. for 1 hour and the HMO was filtered through MILLIPORE nitrocellulose 0.22 μM GSWP filters and washed under vacuum with 10 volumes of deionized water then dried in an oven at 110° C. for 2 hours, thus forming a dried HMO containing copper; and
4. the dried HMO of step 4 was ground to a fine powder using a mortar and pestle, thus making the HMO of Example 5.

### Example 5a

Copper addition to HMO was made in a laboratory using cupric chloride according to the following methodology.
1. 1 gram (g) of a dried sulfurized HMO of Example 3 was stirred in 20 milliliters (mL) of deionized water for 30 minutes using a stir bar and stir plate, thus making a suspension of step 1;
2. 0.2 grams (g) of copper chloride dihydrate was added to the suspension of step 1, thus making the suspension of step 2;
3. the suspension of step 2 was stirred at room temperature for 1 hour and the HMO was filtered through MILLIPORE nitrocellulose 0.22 μM GSWP filters and washed under vacuum with 10 volumes of deionized water then dried in an oven at 110° C. for 2 hours, thus forming a dried HMO containing copper; and
4. the dried HMO of step 4 was ground to a fine powder using a mortar and pestle, thus making the HMO of Example 5a.

### Example 5b

Copper addition to HMO was made in a laboratory using cupric bromide according to the following methodology. Bromide, like copper, as described herein above, is maintained within the manganese sorbent matrix. In addition to cupric bromide, other metal salts may be used in embodiments of the present invention. Without being bound by specific examples, transition metal halides, including transition metal iodides and chlorides, may be used in embodiments of the present invention.
1. 1 gram (g) of a dried sulfurized HMO of Example 3 was stirred in 20 milliliters (mL) of deionized water for 30 minutes using a stir bar and stir plate, thus making a suspension of step 1;
2. 0.2 grams (g) of copper(II) bromide was added to the suspension of step 1, thus making the suspension of step 2;
3. the suspension of step 2 was stirred at room temperature for 1 hour and the HMO was filtered through MILLIPORE nitrocellulose 0.22 μM GSWP filters and washed under vacuum with 10 volumes of deionized water then dried in an oven at 110° C. for 2 hours, thus forming a dried HMO containing copper; and
4. the dried HMO of step 4 was ground to a fine powder using a mortar and pestle, thus making the HMO of Example 5a.

### Example 5c

Copper addition to HMO was made in a laboratory using cupric chloride according to the following methodology.
1. 1 gram (g) of a dried sulfurized HMO of Example 3 was stirred in 20 milliliters (mL) of deionized water for 30 minutes using a stir bar and stir plate, thus making a suspension of step 1;
2. 0.2 grams (g) of copper chloride dihydrate was added to the suspension of step 1, thus making the suspension of step 2;
3. the suspension of step 2 was stirred at 60° C. for 1 hour and the HMO was filtered through MILLIPORE nitrocellulose 0.22 μM. GSWP filters and washed under vacuum with 10 volumes of deionized water then dried in an oven at 110° C. for 2 hours, thus forming a dried HMO containing copper; and
4. the dried HMO of step 4 was ground to a fine powder using a mortar and pestle, thus making the HMO of Example 5c.

### Example 5d

Copper addition to HMO was made in a laboratory using cupric bromide according to the following methodology.
1. 1 gram (g) of a dried HMO of Example 3 was stirred in 20 milliliters (mL) of deionized water for 30 minutes using a stir bar and stir plate, thus making a suspension of step 1;
2. 0.2 grams (g) of copper(II) bromide was added to the suspension of step 1, thus making the suspension of step 2;
3. the suspension of step 2 was stirred at 60° C. for 1 hour and the HMO was filtered through MILLIPORE nitrocellulose 0.22 μM GSWP filters and washed under vacuum with 10 volumes of deionized water then dried in an oven at 110° C. for 2 hours, thus forming a dried HMO containing copper; and
4. the dried HMO of step 4 was ground to a fine powder using a mortar and pestle, thus making the HMO of Example 5d.

### Example 5e

Copper addition to HMO was made in a laboratory using cupric sulfate followed by sulfurization using ammonium sulfide according to the following methodology.
1. 1 gram (g) of a dried HMO of Example 3 and 0.18 gram (g) of CuSO₄.5H₂O was stirred in 4 milliliters (mL) of deionized water for 10 minutes using a stir bar and stir plate, thus making a suspension of step 1;
2. the suspension of step 1 was placed in an oven to remove the water, thus making the solids of step 2;
3. the solids of step 2 were added to 15 milliliters (mL) of deionized water, thus making the suspension of step 3;
4. 200 microliters (μL) of an approximately 44% w/w solution of ammonium sulfide was added to the suspension of step 3, thus making the suspension of step 4;
5. the suspension of step 4 was stirred at 60° C. for 1 hour and the HMO was filtered through MILLIPORE nitrocellulose 0.22 μM GSWP filters and washed under vacuum with 10 volumes of deionized water then dried in an oven at 110° C. for 2 hours, thus forming a dried HMO containing copper; and
6. the dried HMO of step 5 was ground to a fine powder using a mortar and pestle, thus making the HMO of Example 5c. The percent sulfur in the HMO of Example 5e was determined to be 2.195%.

In preparing HMO containing copper the following variations apply. Other crystal forms of hydrous manganese oxide can be used in this process. The crystal forms include but are not limited to beta manganese oxide, delta manganese oxide, and hausmannite. Furthermore, other methodologies for making hydrous manganese oxide can be used in this process other than the ones described above. Other metal salts can be used in the process including but not limited to copper bromide, copper sulfate, ammonium bromide, and potassium iodide. The pH for water used in preparing the metal-containing HMO of the present invention and embodiments thereof is preferably in the range of 0.9 to 8. The pH of the water used in preparing such HMO's may range from 0.9 to 14. The temperature at which the suspensions of the metal-containing HMO's are stirred can range from 20° C. to 60° C.

The percent copper in a copper containing HMO of the present invention and embodiments thereof is preferably from about 3% to about 5% and can range from about 1% to about 30% by weight.

Percent copper in the HMO of Examples 5a through 5c was determined by adding 20 milligrams of the copper-containing HMO to 2 milliliters of 30% w/w/hydrogen peroxide in 13 milliliters w/w HCl. The suspension was heated at 65° C. until all solids were digested, typically 10 to 15 minutes, then the solution was filtered through a MILLIPORE nitrocellulose 0.22 μM GSWP filter. The filtered samples were run on a PERKIN ELMER Optima 3300 RL ICP with a PERKIN ELMER S10 Autosampler to determine copper content.

In Example 5, 0.023 mole of the dried HMO of Example 3 was treated with 0.1 equivalent, or 0.0023 mole, of copper chloride dihydrate according to the methodology of Example 5. The percentage of copper in the HMO of Example 5a was determined to be 4.28%. The percentage of copper in the HMO of Example 5b was determined to be 7.37%. The percentage of copper in the HMO of Example 5c was determined to be 7.30%. The percentage of copper in the HMO of Example 5d was determined to be 7.86%. The percentage of copper in the HMO of Example 5c was determined to be 9.74%.

While examples illustrate the use of cupric chloride and cupric bromide in making copper-modified HMO's of the present invention and without being bound by specific examples, other copper compounds such as cupric iodide and other copper(II) compounds may also be used. Furthermore, other transition metals, such as iron or zinc may also be used in the formulations of the embodiments of the present invention with the transition metal being introduced into such formulations as a transition metal salt.

### Example 6

Iodized HMO was made in a laboratory using potassium iodide according to the following methodology.
1. 1 gram (g) of dried HMO of Example 1a was stirred in 20 milliliters (mL) of deionized water for 30 minutes using a stir bar and stir plate thus making a suspension of step 1;
2. 0.1 gram (g) of potassium iodide was added to the suspension of step 1, thus making the suspension of step 2;
3. the suspension of step 2 was stirred at 60° C. for 1 hour and then filtered through MILLIPORE nitrocellulose 0.22 μM GSWP filters and washed under vacuum with 10 volumes of deionized water then dried in an oven at 110° C. for 2 hours, thus forming a dried iodized HMO; and
4. the dried iodized HMO of step 3 was ground to a fine powder using a mortar and pestle, thus making the iodized HMO of Example 6. The percent iodine in the HMO of Example 6 was determined to be 7.0%.

### Example 7

Brominated HMO was made in a laboratory using ammonium bromide according to the following methodology.
1. 4 grams (g) of dried HMO of Example 1a was stirred in 50 milliliters (mL) of deionized water for 30 minutes using a stir bar and stir plate thus making a suspension of step 1;
2. 2.51 grams (g) of ammonium bromide was added to the suspension of step 1, thus making the suspension of step 2;
3. the suspension of step 2 was stirred at 60° C. for 1 hour and then filtered through MILLIPORE nitrocellulose 0.22 μM GSWP filters and washed under vacuum with 10 volumes of deionized water then dried in an oven at 110° C. for 2 hours, thus forming a dried sulfurized HMO; and
4. the dried sulfurized HMO of step 3 was ground to a fine powder using a mortar and pestle, thus making the brominated HMO of Example 7.

While examples illustrate the use of potassium iodide and ammonium bromide in making halogen-modified HMO's of the present invention, other halogen compounds such as calcium bromide, calcium chloride, calcium iodide, hydrogen bromide, hydrogen chloride and hydrogen iodide may also be used. Furthermore, bromine, chlorine and iodine may be used in making the halogen-modified HMO's of the embodiments of the present invention. The percent halogen present in the halogen containing HMO of the present invention is preferably from about 1% to about 60% w/w.

### Scale Up of the Manufacture of HMO's

The methods for making the HMO of Examples 1 and 2, and the modified HMO of Examples 4 and 5, were scaled up to make larger quantities of the respective HMO's according to the following Examples 8-11.

### Example 8

δ-Hydrous Manganese Oxide scale up. 560 grams (g) of sodium permanganate in 2.8 liters (L) of a 20% w/w aqueous solution was added to 8 liters (L) of deionized water via pump followed by 990 grams (g) of manganese sulfate monohydrate in 3.3 liters (L) of a 30% w/w aqueous solution. The mixture was stirred at room temperature overnight using an overhead mechanical stirrer. The HMO formed was filtered through ADVANTEC Grade 102, 257 mM disc filters and washed via aspiration with 10 volumes of deionized water then placed in an oven at 110° C. until dried. The HMO was ground to a fine powder using a mortar and pestle.

### Example 8a

δ-Hydrous Manganese Oxide scale up. Sodium permanganate in 2.85 liters (L) of a 20% w/w aqueous solution was added to 4 liters (L) of deionized water via pump; followed by manganese sulfate monohydrate in 3.3 liters (L) of a 30% w/w aqueous solution; followed by 4 liters (L) of deionized water. The mixture was stirred at room temperature overnight using an overhead mechanical stirrer. The HMO formed was filtered through ADVANTEC Grade 102, 257 mM disc filters and washed.

### Example 9

β-Hydrous Manganese Oxide scale up. 450 grams (g) of manganese sulfate monohydrate in 1.5 liters (L) of a 30% w/w aqueous solution was added to 2 liters (L) of deionized water via pump followed by 204 milliliters (mL) of concentrated nitric acid, forming a solution. The solution was heated to reflux. 310 grams (g) of sodium permanganate in 1.55 liters (L) of a 20% w/w aqueous solution was then added slowly via pump to the solution to maintain reflux and thereby formed a suspension. The suspension was refluxed overnight then cooled to room temperature, thus forming an HMO. The HMO was filtered through ADVANTEC Grade 102, 257 mM disc filters and washed via aspiration with 10 volumes of deionized water and placed in an oven at 110° C. until dry. The dried HMO was ground to a fine powder using a mortar and pestle.

### Example 10

Sulfurization of δ-HMO using sodium sulfide scale up. 60 grams (g) of dried HMO from Example 8a was stirred and suspended in 1 liter (L) of deionized water overnight using an oversized stir bar and stir plate. 10.8 grams (g) of sodium sulfide was added to the suspension then stirred rapidly at room temperature for 1 hour. The HMO was filtered through ADVANTEC Grade 102, 257 mM disc filters and washed via aspiration with 10 volumes of deionized water and placed in an oven at 110° C. until dry. The HMO was ground to a fine powder using a mortar and pestle. The HMO thus obtained contained 6.16% sulfur.

### Example 10a

Sulfurization of β-HMO using sodium sulfide scale up. 60 grams (g) of dried HMO from Example 9 was stirred and suspended in 1 liter (L) of deionized water overnight using an oversized stir bar and stir plate. 10.8 grams (g) of sodium sulfide was added to the suspension then stirred rapidly at room temperature for 1 hour. The HMO was filtered through ADVANTEC Grade 102, 257 mM disc filters and washed via aspiration with 10 volumes of deionized water and placed in an oven at 110° C. until dry. The HMO was ground to a fine powder using a mortar and pestle. The HMO thus obtained, contained 4.29% sulfur.

### Example 10b

Addition of Cupric Chloride to sulfurized δ-HMO scale up. 400 grams (g) of the sulfurized HMO from Example 10 was suspended in 4 liters (L) of deionized water and stirred overnight. 40 grams (g) of CuCl₂.2H₂O was added to the suspended sulfurized HMO. The resulting suspension was then stirred for 1 hour. The resulting HMO was filtered through ADVANTEC Grade 102, 257 mM disc filters and washed via aspiration with 8 volumes of deionized water and placed in an oven at 110° C. until dry. The HMO was ground to a fine powder using a mortar and pestle. The HMO thus obtained, contained 5.5% copper and 5.74% sulfur.

With respect to Examples 10-10b, other sulfides can be used including but not limited to ammonium sulfide.

### Example 11

Copper addition to HMO scale up. 400 grams (g) of the dried HMO from Example 8 was stirred in 4 liters (L) of deionized water overnight using an overhead mechanical stirrer, thus forming a suspension. 40 grams (g) of copper chloride dihydrate was added to the suspension. The suspension was stirred rapidly at 22 C. for 1 hour. The HMO was filtered through ADVANTEC Grade 102, 257 mM disc filters and washed via aspiration with 10 volumes of deionized water and placed in an oven at 110° C. until dry. The HMO was ground to a fine powder using a mortar and pestle.

The method of mixing is important to the preparation of the HMOs of the present invention and embodiments thereof. The methods of the present invention, as illustrated in the examples, allows for the placement of an oxidizable material on an oxidant without oxidizing the oxidizable material prior to it being adsorbed on to the oxidant. The HMO must be completely suspended in water with no settled product on the bottom of the vessel containing the suspension. If HMO is permitted to settle during, for example, the sulfurization step, then polysulfides will be produced. However, by completely suspending the HMO in water during the sulfurization step, sulfurized HMO is produced. Likewise, by completely suspending the HMO in water during the placement of an oxidizable material on the HMO during the placement step, the oxidizable material is not oxidized until after it is adsorbed.

Surprisingly, the HMOs of the embodiments of the present invention are not agglomerated and are effectively dc-agglomerated, as compared to hydrous manganese oxides of the prior art which are typically agglomerates. As used herein, non-agglomerated or de-agglomerated HMOs refer to the condition where more than eighty percent (80%) of the HMO particles have an average diameter of 100 microns (μm) or less, based on photomicrographic analysis. Particle size analysis of a δ-HMO of the present invention, using a SHIMADZU SALD-2001 particle analyzer available from Shimadzu Scientific Instruments, Inc., Columbia, Md., demonstrates that 99.6% of the particles range in diameter from approximately 0.1 micron to 5.6 micron. Particle size for HMOs of the present invention can range from about 0.1 micron to about 100 micron. Additionally, the surface area of the HMOs of the present invention and embodiments thereof are surprisingly large. Surface area measurements, using a MICROMETRICS TRISTAR II surface area analyzer available form Micrometrics, Norcross, Ga., demonstrate that an HMO of the present invention has a BET surface area of nominally 513 square meter per gram (m²/g).

The particle size distribution, lack of significant agglomeration and large surface area, distinguish the HMOs of the present invention and embodiments thereof from hydrous manganese oxides of the prior art.

### Adsorption Testing of HMO's

The following protocol (“HMO Testing Protocol”) for mercury adsorption testing using HMO's of embodiments of the present invention was followed.
1. 500 microliters (A) of a 0.1% aqueous solution of mercury (II) chloride was added to 500 milliliters (mL) of deionized water in a 1 liter (L) flask, thus forming a mercury solution.
2. The mercury solution was stirred at 100 revolutions-per-minute (rpms) using a stir bar and stir plate.
3. 13 milligrams (mg) of dried hydrous manganese oxide was then added, thus forming a suspension containing 15 parts-per-million (ppm) of HMO.
4. 14 milliliter (mL) samples of the suspension were removed via pipette at time intervals of 0, 1, 10, 20 and 30 minutes.
5. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

Mercury salts other than mercuric chloride can be used in the process including but not limited to mercury (I) chloride. pH ranges for water tested include but is not limited to 3 to 10.6. The pH was adjusted using sodium hydroxide or potassium hydroxide. The HMO can also be added as a 1.73 mg/mL aqueous suspension.

The following Table 2 provides results of mercury adsorption tests following the HMO Testing Protocol described above. Mercury removed is expressed a percentage of the total weight of mercury present in aqueous solution that was removed. The percent mercury removed is the maximum percent mercury removed based on the testing of samples removed at 0, 1, 10, 20 and 30 minutes per the HMO Testing Protocol.

TABLE 2

| | percent mercury |
|---|---|
| HMO Type | removed |
| HMO of Example 1a | 99.26; 97.01 |
| HMO Example 2 | 40.73 |
| HMO of Example 3; sulfurized by (NH₄)₂S | 98.98 |
| HMO of Example 4, sulfurized by Na₂S | 99.20; 97.33 |
| HMO of Example 1a in tap water | 84.04 |
| HMO of Example 6; iodized HMO | 82.55 |
| HMO of Example 7; brominated HMO | 72.88 |
| HMO of Example 5a; CuCl₂ added @ room temperature | 76.84 |
| HMO of Example 5b; CuBr₂ added @ room temperature | 69.92 |
| HMO of Example 5c; CuCl₂ added @ 60° C. | 49.30 |
| HMO of Example 5d; CuBr₂ added @ 60° C. | 61.21 |
| HMO of Example 10, sulfurized by Na₂S | 84.52 |
| HMO of Example 10a, sulfurized by Na₂S | 85.09 |
| HMO of Example 10b, sulfurized by Na₂S with CuCl₂ | 89.18 |

The capacity of the HMO of the embodiments of the present invention to remove mercury was also tested following the HMO Testing Protocol described above. The results as compared to control samples are presented below in Table 3. Mercury removed is expressed as a percentage of the total weight of mercury present in aqueous solution that was removed. The percent mercury removed is the maximum percent mercury removed based on the testing of samples removed at 0, 1, 10, 20 and 30 minutes per the HMO Testing Protocol.

TABLE 3

| | percent |
|---|---|
| | mercury |
| HMO Type | removed |
| HMO of Example 10; scale up sulfurized | 83.01 |
| by Na₂S | |
| HMO of Example 4, sulfurized by Na₂S | 83.43 |
| HMO of Example 3; sulfurized by (NH₄)₂S | 81.02 |

The following Table 4 provides results of mercury adsorption tests following a modification of the HMO Testing Protocol wherein the concentration of the HMO was varied as noted in the Table 2. Samples of the HMO suspension and mercury-bearing solution were removed, filtered per the HMO Testing Protocol, and analyzed for mercury at 0, 45 and 60 minutes. The percent mercury removed is the maximum percent mercury removed based on the testing protocol.

TABLE 4

| HMO concentration | Amount of 0.1% HMO | percent mercury |
|---|---|---|
| (ppm) | suspension added (mL) | removed |
| 0 | 0 | 0 |
| 1 | 0.5 | 48.1 |
| 5 | 2.5 | 89.3 |
| 10 | 5 | 94.8 |
| 15 | 7.5 | 97.1 |
| 20 | 10 | 96.9 |

The effect of pH on the removal efficiency of a sulfurized HMO made according to Example 3 was tested. Table 3 presents the results of mercury removal tests following a further modification to the HMO Testing Protocol wherein ca. (“approximately”) 10 milligrams (mg) of mercuric chloride was added to 100 milliliters (mL) of deionized water. Five such solutions were prepared in separate flasks. The pH of each solution was adjusted with NaOH to the values listed in the Table 3. To each pH adjusted solution, ca. 100 milligrams (mg) of a dried sulfurized HMO, made according to Example 3 of the present invention, was added. The thus formed suspensions were stirred overnight at room temperature. Single 14 milliliter (mL) samples of each suspension were removed via pipette and immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

TABLE 5

| | | milligrams of | percent |
|---|---|---|---|
| Flask | | sulfurized HMO | mercury |
| No. | pH | added | removed |
| 1 | 3.21 | 100.3 | 76.77 |
| 2 | 4.68 | 100.4 | 84.37 |
| 3 | 7.02 | 100.9 | 85.14 |
| 4 | 8.16 | 100.9 | 87.20 |
| 5 | 10.11 | 101.3 | 88.76 |

### Removal of Certain Pollutants at Elevated Temperatures by Certain Sorbents

The sorbents illustrative of embodiments of the present invention were studied for their ability to remove mercury, sulfur oxide, and hydrochloric acid from a gas stream at elevated temperatures. The sorbents were compared with activated carbon and PRB fly ash in terms of their ability to capture these pollutants from a simulated flue gas.

The effect of the sorbents of the embodiments of the present invention on fly ash quality was also studied. The foam index of each sorbent type was compared with PRB fly ash and activated carbon to determine whether the sorbents would yield the fly ash unusable as a cement additive. Activated carbon, for example, will render a fly ash unusable as a cement additive. PRB fly ash is fly ash derived from the combustion of Powder River Basin Coal. PRB fly ash is a known additive to cement.

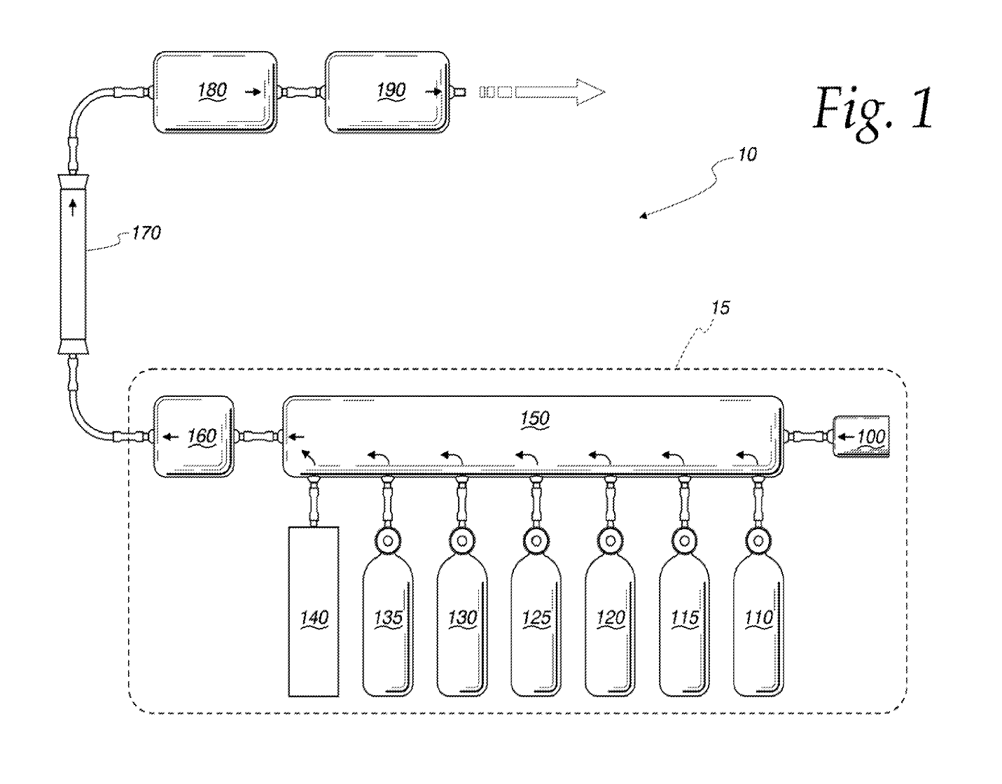

As illustrated in the schematic in FIG. 1, the efficacy tests on vapor phase pollutants were conducted using a test apparatus 10 which included a quartz furnace 170, a continuous emission monitor 180, a Fourier transform infrared (“FTIR”) spectrometer 190, and a gas-flow control system 15. The gas flow control system 15 included a water vaporization unit 100, a mass flow controller 150 and a gas injector 160. The gases used in the efficacy experiments to provide a simulated flue gas were stored in compressed-gas cylinders 110, 115, 120, 125, 130, and 135, for example, which were then mixed to known concentrations by use of mass flow controllers 150.

The FTIR spectrometer 190 used in the efficacy testing was an MKS MULTIGAS 2030 HS monitor. This FTIR spectrometer is a high speed, high resolution FTIR-based gas analyzer. The MKS MULTIGAS 2030 HS monitor is available from MKS Instruments 2 Tech Drive, Suite 201, Andover, Mass. Mercury emissions were measured using a TEKRAN 2537A mercury vapor analyzer. The TEKRAN 2537A samples air and traps mercury vapor in a cartridge containing a gold adsorbent. The adsorbed mercury is thermally desorbed and detected using Cold Vapor Atomic Fluorescence Spectrometry (CVAFS). The Tekran 2537A analyzer is available from Tekran Instruments Corporation, 230 Tech Center Drive, Knoxyille, Tenn. Gas flow rates, temperatures, and concentrations were continuously monitored and maintained electronically.

Controlled evaporating liquid water generated the appropriate moisture content in the simulated flue gas stream via the water vaporization unit 100. The gas stream 165, comprising gases from compressed gas cylinders 110, 115, 120, 125, 130, and 135, and water vapor from water vaporization unit 100, for example was well mixed and preheated before entering the quartz furnace 170. As an example, the gas cylinders contained the following gases:

TABLE 6

| Gas Cylinder | Gas |
|---|---|
| 110 | SO₂ |
| 115 | NO |
| 120 | CO₂ |
| 125 | O₂ |
| 130 | HCl |
| 135 | N₂ |

Mercury was added via mercury addition system 140. Mercury addition system 140 comprised a long tube residing in a chamber, wherein the long tube was packed with vermiculite that had been soaked in mercury. The chamber was held at a temperature and pressure such that a mercury concentration of about 10 microgram per cubic meter (μg/m³) was generated in air flowing through the tube. The mercury concentration of air discharged from the mercury addition system 140 was confirmed by measuring the mercury content directly using the TEKRAN 2537A mercury vapor analyzer.

The quartz furnace 170 comprises a three (3) inch diameter tube furnace which heats a one-and-one-half (1½) inch diameter by three (3) foot long tubular reaction chamber. The reaction chamber carries the gases through the furnace while holding the sorbent samples in place. All heated sections of the quartz furnace 170 are made of quartz glass to limit wall effects.

The efficacy experiments included the collection of baseline data using an empty (blank) quartz furnace 170. Desired gas concentrations for the simulated flue gas using SO₂, NO, CO₂, O₂HCl, N₂, and H₂O were obtained using the mass flow controller 150. The gas concentrations were then confirmed by outlet-gas composition measurements using FTIR spectrometer 190. At the start of each efficacy test, the blank quartz furnace 170 was removed, and a quartz furnace 170 loaded with sorbent was inserted in its place. During each test, the quartz furnace 170 was quickly heated to the desired temperature. In tests in which the quartz furnace 170 contained sorbent samples, the sorbent samples were exposed to the simulated flue gas flow, and the resulting exit gas concentrations were measured using the FTIR spectrometer 190. Once a test had concluded, the quartz furnace 170 containing the sorbent was removed and replaced with the blank quartz furnace 170 to re-establish the baseline.

A sorbent loading of 0.75 grams mixed in 56.7 grams of sand was used in testing all sorbents. This particular mixture was chosen to allow the most dispersed sorbent configuration possible. The pore structure of the bed of sand yielded a surface area greater than a mono-layer coverage by the 0.75 grams of sorbent. Accordingly, most of the sorbent was present on the surface of the sand-bed pore walls, and was only of single-particle thickness.

The gas composition and test parameters used for all tests are shown Table 7. Gas concentration values are listed as dry concentrations at the actual oxygen concentration. Gas flow rates are reported at standard conditions. Standard conditions for the efficacy tests described herein were 70° F. (21.1° C.) and 1 atmosphere of pressure.

TABLE 7

| Parameter | Value |
|---|---|
| Total System Flow Rate (l/min) | 7.500 |
| Sorbent, Sand Loading | 0.75 grams sorbent per 56.7 grams sand |
| Test Duration (minutes) | approximately 70 |
| Temperature | 350° F. (177° C.) and 600° F. (316° C.) |
| Sulfur Dioxide | 300 ppmv |
| Nitrogen Oxide | 150 ppmv |
| Carbon Dioxide | 12% |
| Oxygen | 3% |
| Water vapor | 8% |
| Hydrogen Chloride | 5 ppmv |
| Hg | 20 μg/m³ |
| Nitrogen | Balance |

### Results of Efficacy Testing

The removal percentages of inlet gas species was determined by taking an average of the species concentration in the reactor outlet gas over the entire 70-minute test period. The mercury removal percentages are presented in Table 8 for each sorbent tested. As noted in Table 7 separate tests were run at two temperatures, namely 350° F. and 600° F.

TABLE 8

| | | 350° F. | 600° F. |
|---|---|---|---|
| | | Percent Hg Removal | |
| Norit FGD | | 96.4 | 47.36 |
| HMO of Example 3 | Sample 1 | 95.2 | 48.32 |
| HMO of Example 10a | Sample 2 | 77.1 | 56.83 |
| HMO of Example 5 | | 95.4 | 63.68 |

NORIT FGD is sold under the trade name DARCO FGD. DARCO FGD is a lignite coal-based activated carbon manufactured specifically for the removal of heavy metals and other contaminants typically found in incinerator flue gas emission streams. DARCO FGD is available from Norit Americas Inc., 3200 University Avenue, Marshall, Tex. NORIT FGD is the standard against which the other sorbents was compared.

Table 9 shows the HCl and SO₂ percent removal data for each efficacy test conducted.

TABLE 9

| | | 350° F. | 350° F. | 600° F. | 600° F. |
|---|---|---|---|---|---|
| | | removal % | removal % | removal % | removal % |
| | | HCl | SO₂ | HCl | SO₂ |
| Norit FGD | | 22.97 | 0.45 | 0.00 | 0.00 |
| HMO of | Sample 1 | 58.62 | 6.45 | 88.98 | 29.56 |
| Example 3 | | | | | |
| HMO of | Sample 2 | 47.15 | 2.86 | 28.38 | 5.02 |
| Example 10a | | | | | |
| HMO of | | 86.16 | 6.47 | 75.86 | 9.39 |
| Example 5 | | | | | |

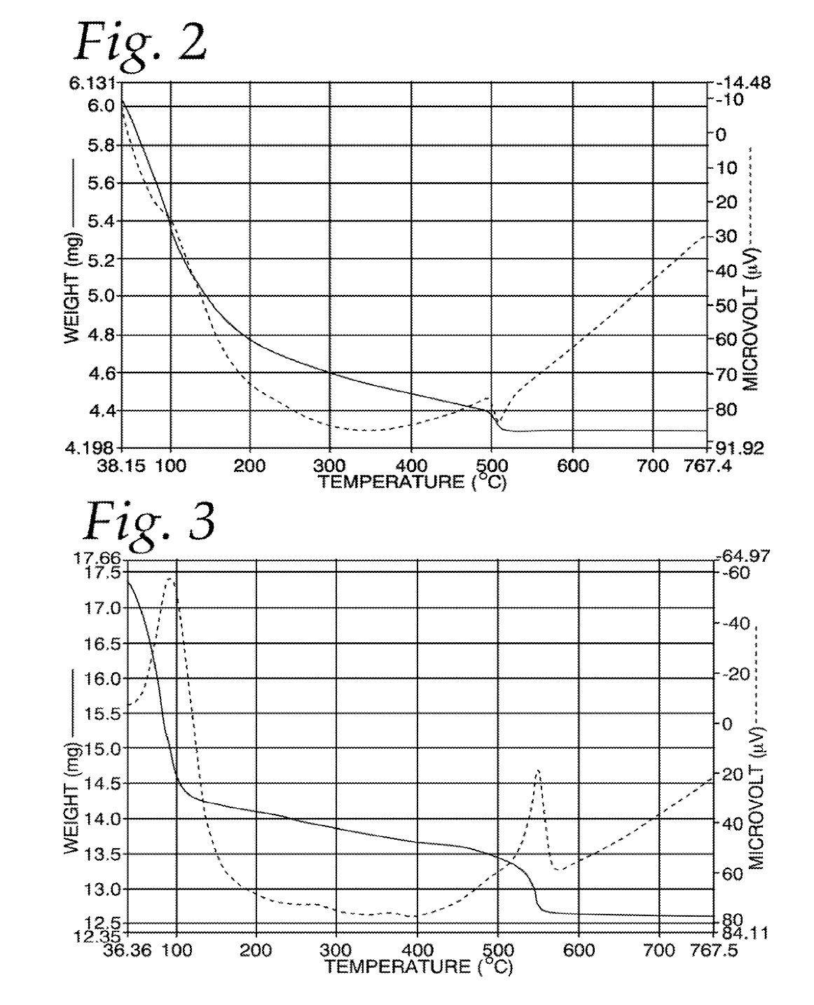

With reference to FIGS. 2 and 3, thermal analyses demonstrate that the structure of the manganese sorbents of the present invention and embodiments thereof is stable up to at least 500° C. (932° F.). Digital thermogravimetric analyses were performed using a PERKIN ELMER DIAMOND TG/DTA analyzer. Accordingly, the sorbents embodied in the present invention would be effective in removing mercury fluids at temperatures up to at least 500° C.

### Foam Index Testing of Certain Sorbents

The foam index test was applied to determine if the sorbents of the present invention and embodiments thereof would be detrimental to the use of fly ash containing the sorbents as a cement additive. The test is further described in Grace Construction Products, “The Foam Index Test: A Rapid Indicator of Relative AEA Demand,” Technical Bulletin TB-0202, February 2006. The index determined for each sorbent tested in the efficacy testing mixed with Portland cement was compared to the indices for PRB coal ash and activated carbon, respectively. PRB coal fly ash is a known acceptable cement additive. Activated carbon, on the other hand, is a known unacceptable cement additive.

Approximately 4 grams (g) of a sample was mixed with 16 grams (g) of Portland cement in 50 milliliters (mL) of water. An air-entraining agent (AEA) was added drop wise to the mixture of sample, cement and water. When foam covered the entire surface of the mixture without breaks and persisted in that condition for 45 seconds, the amount of AEA used was recorded. Table 10 shows the average amounts of AEA added for three tests after subtracting out the amount of AEA needed to reach the endpoint of Portland cement by itself. A test with activated carbon was also performed as shown, but even with more than 4.5 mL of AEA, no foam formed. A test run with PRB fly ash as the sample was also run as a control.

TABLE 10

| | Average AEA | St Dev AEA |
|---|---|---|
| | (mL) | (mL) |
| PRB | 0.10 | 0.05 |
| Sample 1; HMO of Example 3 | 0.02 | 0.02 |
| Sample 2; HMO of Example 10a | 0.45 | 0.02 |
| HMO of Example 5 | 0.19 | 0.03 |
| Activated Carbon | 4.55 | — |

The modified hydrous manganese oxide sorbents of the present invention and embodiments thereof have been shown to be as effective as activated carbon at removing mercury at 350° F. and more effective than activated carbon at 600° F. in tests conducted. Furthermore, tests demonstrated that the modified hydrous manganese oxide sorbents of the present invention and embodiments thereof also scavenge significant concentrations of SO₂ and HCl, in comparison to activated carbon which does not remove significant quantities of SO₂ and HCl. Furthermore, the foam index of the modified hydrous manganese oxide sorbents of the present invention and embodiments thereof suggests that a fly ash containing such sorbent is useable as cement additive.

### Leaching Studies

Mercury leaching studies were conducted using an un-modified HMO; a 2% sulfurized HMO, a 7% sulfurized HMO; and NORIT FGD. Two temperatures were studied: room temperature (nominally 25° C.) and 60° C. Results show that the sulfurized HMO samples retains more mercury than the non-sulfurized version and the NORIT FGD activated carbon. Increasing the sulfur content from 0% to 7% also decreases mercury leaching by over 40% where brine (NaCl) test solution was used, but is dependent upon the leaching conditions. Leaching conditions included neutral conditions, acidic, basic, salt water conditions and the use of a complexing agent.

The un-modified HMO was prepared according to the method described in Example 1a. The 2% sulfurized HMO's were prepared according to the methodology of Example 3 but with a reduced amount of ammonium sulfide used to produce 2% sulfurized HMO. The 7% sulfurized HMO's were prepared according to the methodology of Example 3.

The sorbent samples used in the leaching studies described herein were first subjected to mercury adsorption so that the sorbents each held an amount of mercury. The mercury adsorption was done according to the following method.
1. 10 milliliters (mL) of a 0.1% w/w solution of mercury was added to the sorbent;
2. the mercury and HMO were stirred overnight at room temperature (ca. 25° C.); and
3. the mercury and HMO were then filtered through MILLIPORE nitrocellulose 0.22 μM GSWP filters under vacuum, and washed with deionized water.

The leaching tests were performed according to the following method.
1. 25 milligram (mg) samples of HMO were placed in 30 milliliter (mL) vials;
2. 10 milliliters (mL) of the appropriate test solution were added to each vial;
3. the test solutions were, respectively: 1 M (moles/liter) HNO₃, 1 M NaOH, 0.6 M NaCl, or 0.1 M Na₄P₂O₇-10H₂O; and
4. the vials were placed in an oven at 60° C. or in a hood at room temperature.

After a predetermined time (time: 0 control; 1 day; 2 days; 3 days; 7 days; and 14 days), a sample was removed from each vial. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

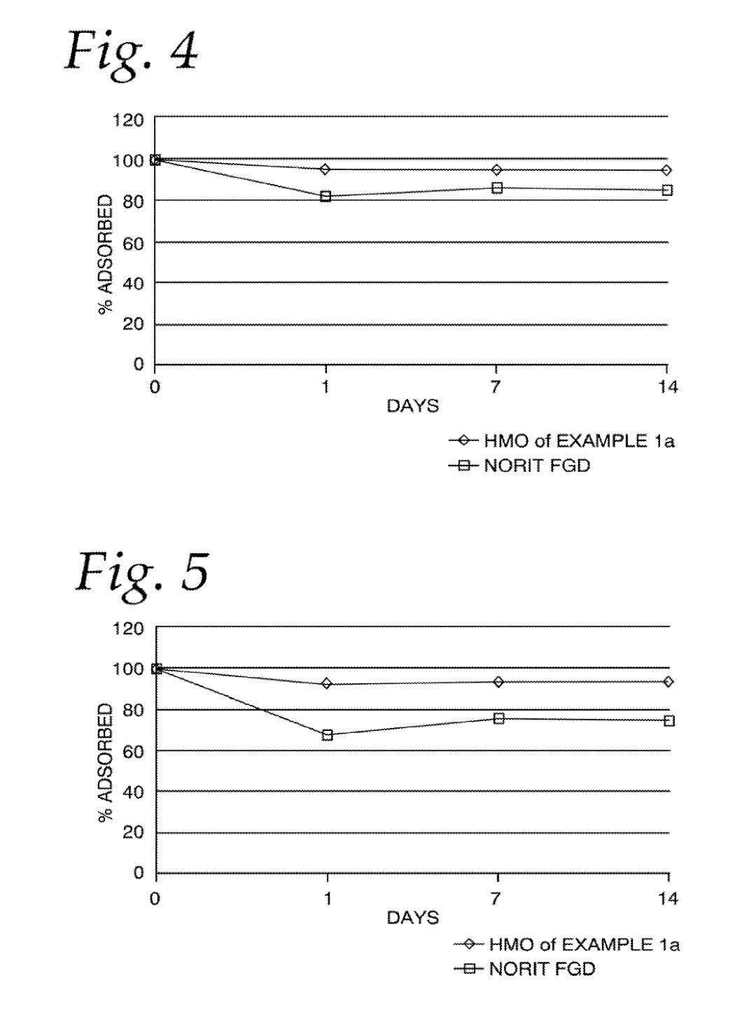

The results of the leaching tests are presented in FIGS. 4-11. As the data presented in FIG. 4 and FIG. 5 demonstrates, the HMO of embodiments of the present invention is significantly less susceptible to leaching mercury than NORIT FGD activated carbon. The leaching studies of FIGS. 4 and 5 were conducted at a neural pH using deionized water according to the procedure described above. After the predetermined time (time: 0 control; 1 day; 2 days; 3 days; 7 days; and 14 days), a sample was removed from each vial. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration. As shown in FIG. 4, NORIT FGD activated carbon leaches approximately 12% more mercury at 25° C. than does the HMO of embodiments of the present invention. As shown in FIG. 5, NORIT FGD activated carbon leaches approximately 20% more mercury at 60° C. than does the HMO of the embodiments of the present invention.

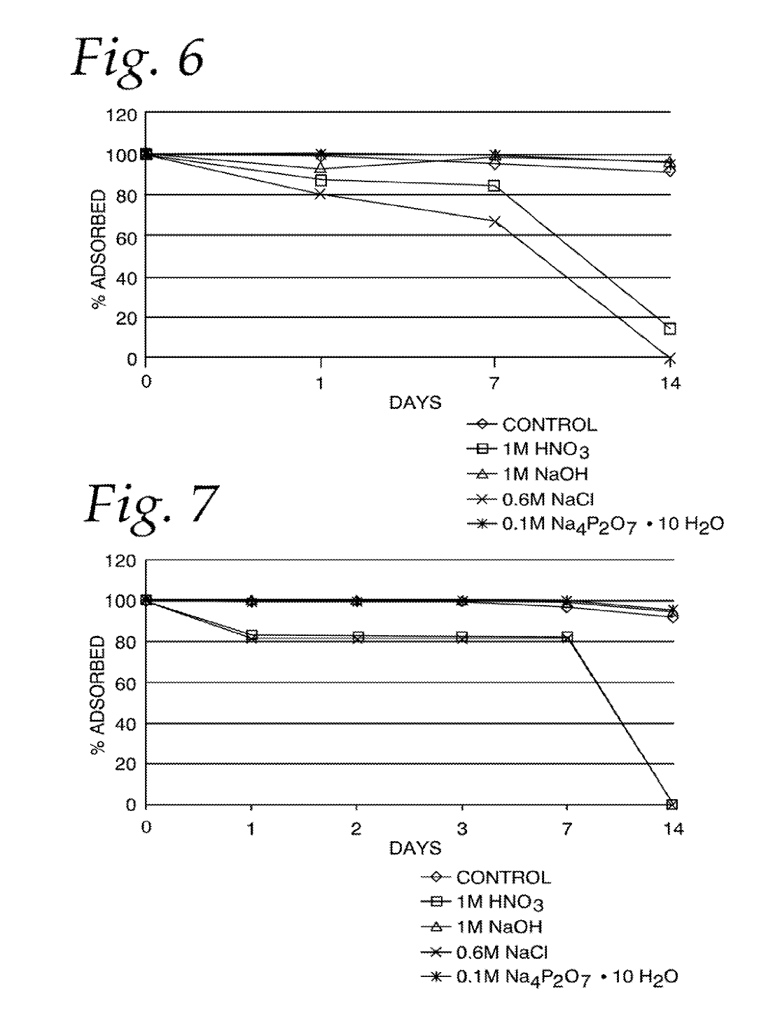

FIGS. 6 and 7 demonstrate the leaching characteristics of a 2% sulfurized HMO of embodiments of the present invention. The 2% HMO samples were prepared with mercury as described above and placed in vials containing deionized water (control), 1 M HNO₃, 1 M NaOH, 0.6 M NaCl₂, and 0.1 M Na₄P₂O₇-10H₂O, respectively. After the predetermined time (time: 0 control; 1 day; 2 days; 3 days; 7 days; and 14 days), a sample was removed from each vial. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

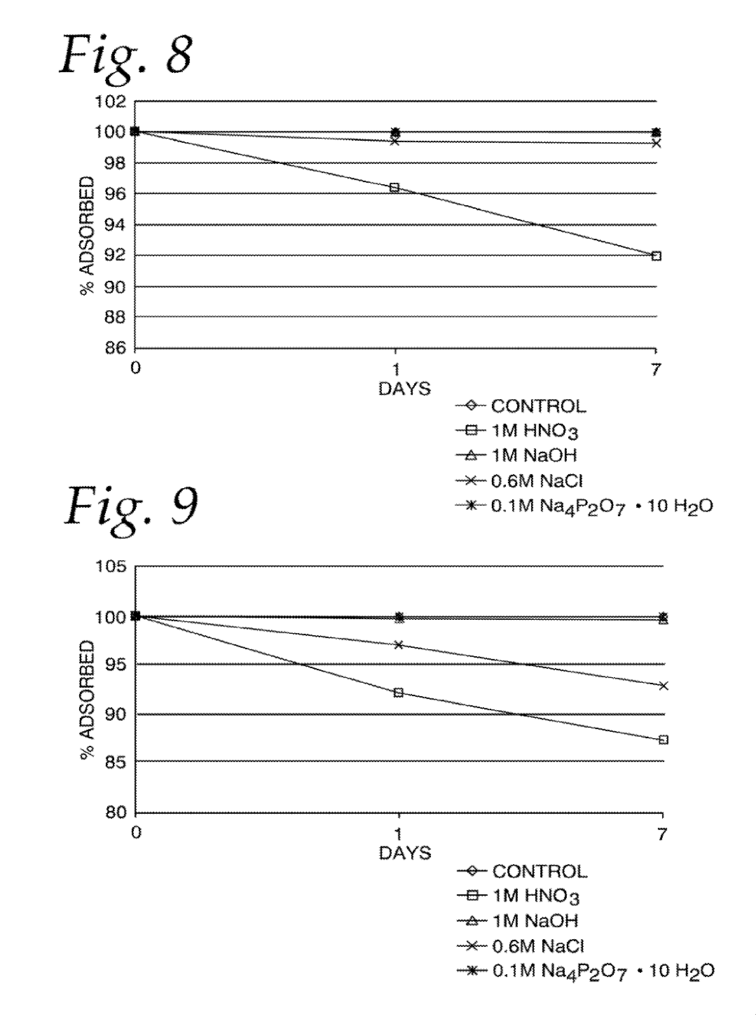

FIGS. 8 and 9 demonstrate the leaching characteristics of a 7% sulfurized HMO of embodiments of the present invention. The 7% HMO samples were prepared with mercury as described above and placed in vials containing deionized water (control), 1 M HNO₃, 1 M NaOH, 0.6 M NaCl₂, and 0.1 M Na₄P₂O₇-10H₂O, respectively. After the predetermined time (time: 0 control; 1 day; 2 days; 3 days; and 7 days), a sample was removed from each vial. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

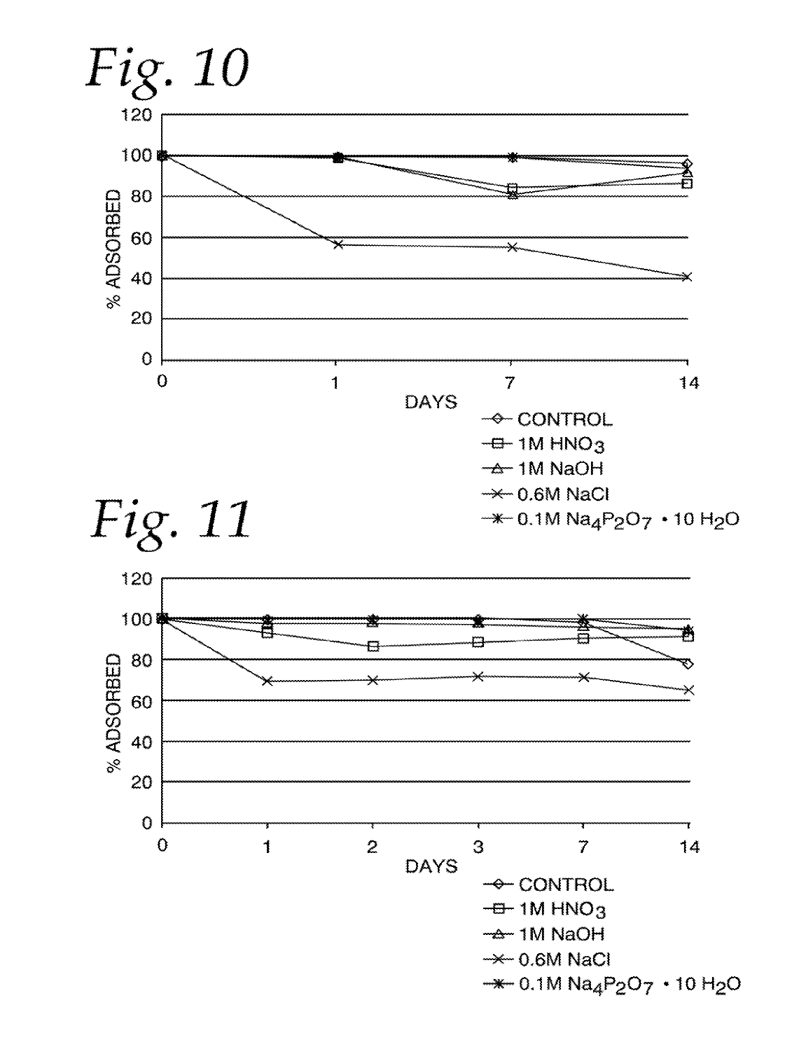

FIGS. 10 and 11 demonstrate the leaching characteristics of an unmodified HMO of embodiments of the present invention. The unmodified HMO samples were prepared with mercury as described above and placed in vials containing deionized water (control), 1 M HNO₃, 1 M NaOH, 0.6 M NaCl₂, and 0.1 M Na₄P₂O₇-10H₂O, respectively. After the predetermined time (time: 0 control; 1 day; 2 days; 3 days; 7 days; and 14 days), a sample was removed from each vial. The samples were immediately filtered through MILLIPORE nitrocellulose 0.22 μM GSWP filters under vacuum. The filtered solutions were diluted and placed on a PERKIN ELMER FIMS 100 Mercury Analysis System using a PERKIN ELMER AS-90 plus autosampler to determine mercury concentration.

Comparing the leaching study results for an unmodified HMO with those for a 2% HMO, it is apparent that mercury retention improves with a greater percentage of sulfurization of the HMO even where the leaching liquid is at an elevated temperature. Furthermore, increasing the sulfurization to 7% produces an even greater improvement in mercury retention under a variety of conditions.

There has been provided in accordance with the present invention and the embodiments thereof, a modified hydrous manganese oxide particle for use as a sorbent for the removal of mercury from a fluid. There has also been provided in accordance with the present invention and embodiments thereof, a method for making a modified hydrous manganese oxide particle. There is further provided in accordance with the present invention and embodiments thereof, methods of applying modified hydrous manganese oxide particles to the removal of mercury from a fluid. While the invention has been described with specific embodiments, many alternatives, modifications and variations will be apparent to those skilled in the art in light of the foregoing description. Accordingly, it is intended to include all such alternatives, modifications and variations set forth within the spirit and scope of the appended claims.

What is claimed is:

1. A sorbent effective for removing mercury from a fluid, the sorbent comprising:
a hydrous manganese oxide having a pore structure; and
a sulfur compound impregnated in the pore structure of the hydrous manganese oxide.

2. The sorbent of claim 1 further comprising a halogen compound, wherein the halogen compound is impregnated in the pore structure of the hydrous manganese oxide.

3. The sorbent of claim 2 wherein the halogen compound is an iodide compound.

4. The sorbent of claim 2 wherein the halogen compound is a bromide compound.

5. The sorbent of claim 1 wherein the sulfur compound is a sulfide compound.

6. The sorbent of claim 5 wherein the sulfide compound is sodium sulfide.

7. The sorbent of claim 1 further comprising a transition-metal-bearing compound, wherein the transition-metal-bearing compound is impregnated in the pore structure of the hydrous manganese oxide.

8. The sorbent of claim 7 wherein the transition-metal-bearing compound contains copper.

9. A method of making a hydrous manganese oxide sorbent effective for removing mercury, the method comprising:
making a first suspension of a hydrous manganese oxide and water;
adding a sulfur-bearing compound to the first suspension, to make a second suspension;
selecting a reaction time and a reaction temperature for the hydrous manganese oxide and sulfur-bearing compound in the second suspension; and
mixing the second suspension for the reaction time at the reaction temperature such that effectively all the hydrous manganese oxide is suspended during the reaction time and such that a sulfurized hydrous manganese oxide is formed.

10. The method of claim 9 further comprising the step of filtering the sulfurized hydrous manganese oxide from the suspension.

11. The method of claim 10 comprising washing the filtered sulfurized hydrous manganese oxide.

12. The method of claim 11 comprising drying the washed and filtered sulfurized hydrous manganese oxide.

13. The method of claim 9 further comprising the step of adding an adjunct compound to the second suspension such that the adjunct compound is mixed with the second suspension for the reaction time at the reaction temperature thereby forming an augmented sulfurized hydrous manganese oxide sorbent.

14. The method of claim 13 wherein the adjunct compound is a halogen compound.

15. The method of claim 13 wherein the adjunct compound is a transition-metal-bearing compound.

16. A hydrous manganese oxide sorbent effective for removing mercury made according to the method of claim 12.

17. A method of making a de-agglomerated hydrous manganese oxide sorbent effective for removing mercury, the method comprising:
combining sodium permanganate and manganese sulfate monohydrate to make a suspension;
selecting a reaction time and a reaction temperature for the reaction of the sodium permanganate and the manganese sulfate monohydrate in the suspension; and
stirring the suspension at the reaction temperature for the reaction time to allow the hydrous manganese oxide to precipitate and such that effectively all of the hydrous manganese oxide is suspended during the reaction time.

18. The method of claim 17 further comprising the step of filtering the hydrous manganese oxide from the suspension.

19. The method of claim 18 comprising washing the filtered sulfurized hydrous manganese oxide.

20. The method of claim 19 comprising drying the washed and filtered sulfurized hydrous manganese oxide.

21. A de-agglomerated hydrous manganese oxide sorbent made according to the method of claim 20.

22. A method for removing mercury from a fluid, the method comprising:
contacting the fluid with a sulfurized hydrous manganese oxide sorbent;
allowing mercury in the fluid to interact with the sulfurized hydrous manganese oxide sorbent such that the mercury is bound to the sulfurized hydrous manganese oxide sorbent forming a mercury-sorbent particle; and
removing the mercury-sorbent particle from the fluid.
